(19) United States
(12) Patent Application Publication
(10) Pub. No.: US 2016/0343013 A1
(43) Pub. Date: Nov. 24, 2016

(54) DEVICE AND METHODS FOR PROVIDING A USER WITH BUSINESS EXPANSION INCENTIVES INFORMATION

(71) Applicant: Michael R. PRESS, Westport, CT (US)

(72) Inventor: Michael R. PRESS, Westport, CT (US)

(21) Appl. No.: 14/719,822

(22) Filed: May 22, 2015

(51) Int. Cl. G06Q 30/02

(52) U.S. Cl. CPC G06Q 30/0205; G06Q 30/0207

(57) ABSTRACT

Methods and apparatuses for utilizing various techniques to enable someone looking to expand their business are provided herein. The present invention transforms disjointed and complicated laws, rules and regulations into a useful tool that enables a person with the ability to have a clear picture of business expansion options available. Options can include one or more locations where incentives for expanding a business are offered. Options can also include the value of available incentives for locations that are preferred by the business person.

### BACKGROUND OF THE INVENTION

This generally relates to devices and methods for helping users make educated decisions on business expansion opportunities. In particular, the present disclosure helps a businessperson determine the potential subsidies that might be available for an expansion of business for one or more locations.

Before the era of globalization, when businesses wanted to expand, they typically did it locally without any thought to try and obtain help from anyone else. Today, in a globalized era, businesses are able to pick up and move at a lower cost and with greater ease. Globalization and its ability to bring everyone closer together has created a competitive environment in which various localities and states often compete with each other to bring in the newest business. One main reason for such competition for new business is the influx of new jobs for a location's citizens, and, accordingly, an influx of revenue into that region's economy, as well as its tax coffers. Tax revenues increase without raising the taxes of local voters.

Given this ease and flexibility of business development in the globalized world, businesses are no longer competing for local land. States and municipalities are now competing for businesses to conduct their affairs in their jurisdictions. In order to win the competition for business, states and municipalities have created laws and regulations designed to entice business to come and grow. These laws and regulations often create incentives that may help a business with the various costs associated with expanding or relocating.

In this competition, each state may seek certain types of businesses. For example, one state might be looking to attract a semi-conductor chip factory while another state might be looking to attract clean energy plants. This can lead each state to have completely different sets of laws, regulations, and resulting incentives. The wide array of laws and regulations may also be applied differently to different areas within each state. Such a vast array of options forces today's businesses to confront numerous, critical technical problems—which state should that business expand in, and to that point, how to perform a complete, accurate, and timely analysis for the business of which local jurisdiction offers the best incentives for that business?

In fact, there are so many rules and regulations that even well-trained corporate finance executives would find it an enormous challenge to determine the available incentives for just one municipality. The amount of effort required even for one state is a huge, almost insurmountable task. The concept that an individual working for a company could evaluate five, ten or even half the states in the United States of America is simply unimaginable. With such a wide array of regulations and kinds of incentives, it is unfeasible and impractical for a business to obtain an accurate analysis of each rule to determine which incentives are best for their particular business. At times, the costs of obtaining an analysis can be greater than the incentives themselves. But without an accurate analysis, maximizing the value of the expansion of a business is, at best, a guess.

Business expansion is a time-sensitive and expensive decision that can make or break a business. If a business waits too long, the opportunity to expand can be missed or become much more expensive. Acting too quickly without a complete and accurate analysis will likely lead a business to make an incorrect decision. The time-sensitive nature of expanding a business presents today's businesses with yet another technical problem of having to act faster than they can analyze all the available incentives. It is an insurmountable task for any business to accurately maximize the value of a business expansion, let alone do it within the window of time allotted for the opportunity to expand.

### SUMMARY OF THE INVENTION

This disclosure generally relates devices and methods for helping users make time-sensitive, educated decisions on business expansion opportunities.

Before expanding, a business may estimate the costs associated with an expansion. In some embodiments, the business may first estimate how much a building to be used for the expansion (e.g., a new facility or warehouse) will cost. Then, the business may estimate how much it will cost to operate their business at that new location. The various costs for operating at the new location may include such factors as how many employees are required and what those employees' salaries will be. These costs are then compared to how much the new location may potentially generate in gross revenue. If the business determines that the revenue outweighs the cost, the business will consider that location to expand to.

Costs have traditionally been viewed as a burden that will be shouldered solely by the business. However, when these costs and other incentives are processed or analyzed in view of incentive rules, the devices and methods disclosed herein may transform these burdens into a list of one or more locations where incentives are offered to help a business with their costs.

In one exemplary embodiment, a device that transforms disjointed, complex incentive rules and indicators into one or more locations where incentives are available for a business expansion is described. This transformation is done quickly and accurately. The device may include memory to store one or more incentive rules. For example, the memory may store incentive rules for all fifty (50) states within the United States of America. The memory may also store incentive rules for other localities within other countries. The device also may include input circuitry that allows a user to input one or more indicators. The indicators may correspond to a number of jobs that the business expansion potentially will create, an average wage of such jobs, and an amount of expense that the business may be planning on spending on long term assets such as equipment or infrastructure. The various indicators and incentive rules may then be quickly and accurately processed or analyzed by one or more processors located on the device. In one exemplary embodiment, the process transforms the incentive rules and indicators into at least one location where incentives for the business expansion may be available. The device also may include output circuitry that may display the results of the analysis to the user in a clear and informative manner.

In another exemplary embodiment, in addition to the indicators described above, the user may further input a geographic preference as an additional indicator for the analysis performed by the one or more processors of the device. For example, if a business wanted to expand, but stay on the east coast of the USA, the user may input an additional indicator that, when analyzed by the one or more processors, indicates the user's preference for the east coast. A processor may then analyze the geographic preference along with the other indicators and incentive rules. The results of this analysis transforms seemingly unrelated incentive rules and indicators into a tangible number. The tangible number may, in some embodiments, correspond to an amount of available incentives for the desired geographic preference. In some embodiments, the results of the analysis, including the tangible number and the amount of the available incentives for the desired geographic preference, may then by displayed using the output circuitry.

In another exemplary embodiment, a method for transforming disjointed, complex incentive rules and indicators into at least one location where incentives are available for a business expansion is described. First, incentive rules may be obtained. These incentive rules, for example may correspond to all of the incentive rules for each of the fifty (50) states within the United States of America. The incentive rules may also correspond to other localities within other countries. Next, indicators may be received from a user. The indicators may correspond to a number of jobs that the business expansion will potentially create, an average wage of those jobs, and an amount of cost that the business may be planning on spending on long term assets such as equipment or infrastructure. Once the user has provided the indicators, the indicators and incentive rules may be quickly and accurately analyzed. In one exemplary embodiment, the analysis transforms the incentive rules and indicators into at least one location where incentives for the business expansion may be available. Next, the results of the analysis may then be displayed to the user in a clear and informative manner.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is an illustrative diagram of the continental United States of America, where each state and each locality, or even, each neighborhood, may have a wide array of incentive rules in accordance with various embodiments;

FIG. 2 is an illustrative diagram of an exemplary device in accordance with various embodiments;

FIG. 3 is an illustrative diagram of a user interface displayed on a device showing various inputted indicators and displayed ranked locations in accordance with various embodiments;

FIG. 4 is an illustrative diagram of another image of the continental United States of America showing a user selected state as a geographic preference in accordance with various embodiments;

FIG. 5 is an illustrative diagram of a user interface displayed on a device showing various inputted indicators and displayed range of incentives in accordance with various embodiments;

FIG. 6 is an illustrative diagram of another user interface displayed on a device showing various inputted indicators and a displayed range of incentives in accordance with various embodiments;

FIG. 7 is an illustrative flowchart of a process for providing a user with one or more business expansion locations in accordance with various embodiments;

FIG. 8 is an illustrative block diagram including various indicators in accordance with various embodiments;

FIG. 9 is an illustrative flowchart of a process for providing a user with ranked business expansion locations in accordance with various embodiments;

FIG. 10 is an illustrative block diagram including various indicators in accordance with various embodiments;

FIG. 11 is an illustrative flowchart of a process for providing a user with available incentives for a geographic preference in accordance with various embodiments; and

FIG. 12 is an illustrative block diagram including various indicators in accordance with various embodiments.

### DETAILED DESCRIPTION OF THE INVENTION

The present invention may take form in various components and arrangements of components, and in various techniques, methods, or procedures and arrangements of steps. The referenced drawings are only for the purpose of illustrated embodiments, and are not to be construed as limiting the present invention. Various inventive features are described below that can each be used independently of one another or in combination with other features. Furthermore, in at least some embodiments, liked referenced numerals refer to like parts throughout.

A business, as described herein, can refer to any person, persons, or organization engaging in an activity that employs a person or persons. Regardless of the economic intentions of a business, expansion is typically one primary goal. The desire to expand is not limited to “for-profit” businesses. For example, since their humble beginnings in Washington D.C. in 1881, the Red-Cross has been trying to provide aid to every corner of the globe. Expanding every day, the Red-Cross has been helping people in Haiti, Japan, Nepal and Pakistan, to name a few. The fact that the Red Cross is a non-profit has not effected its desire to expand.

Expansion, as used herein, is not meant to be limited to an existing business increasing its workforce. Expansion may also, in some embodiments, refer to a business moving to, or opening new branches in, or placing additional machinery in new locations. Expansion may also refer to a new business that is looking to break ground in a location.

A geographic preference, as used herein, may correspond to the entire United States of America, an area in the United States of America (e.g., a state), a grouping of states (e.g., the southwest), a specific state, and/or an area within a state (e.g., a city or county or neighborhood). Furthermore, a geographic preference may, in some embodiments, include additional countries worldwide, as well as various regions or cities within one or more additional countries.

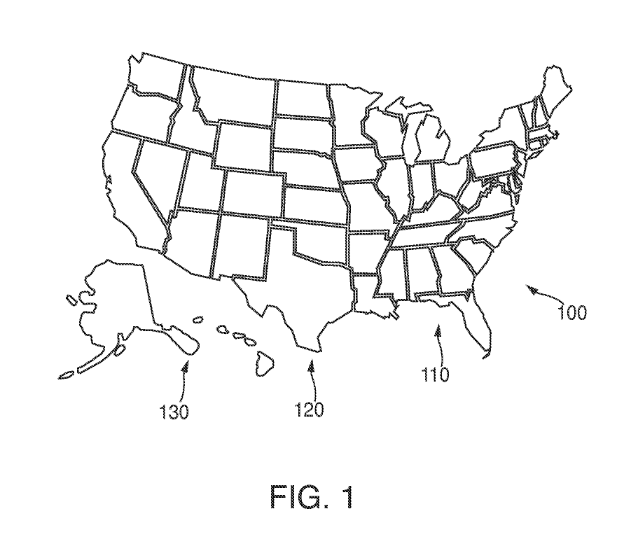

FIG. 1 is an illustrative diagram of the continental United States of America, where each state and each locality, or even, each neighborhood, may have a wide array of incentive rules in accordance with various embodiments. In some embodiments, a map of the United States of America 100 may include various geographic preferences. Such geographic preferences may include, for example, eastern united states 110, central united states 120, western united states 130, or any combination thereof. Each of these geographic preferences brings its own set of incentive rules for businesses that may choose to expand within one of these geographic preferences. For example, eastern united states 110 might attempt to bring in 3-D printing businesses while western united states 130 might want to attract semi-conductor chip factories. This would lead to the eastern united states 110 having incentive rules that favor 3-D printing businesses while the western united states 130 would have incentive rules that favor semi-conductor chip factories. Furthermore, a geographic preference may, in some embodiments, be a grouping of states (e.g., the northeast), a specific state, an area within a state (e.g., a city or county or neighborhood), and/or any combination therein.

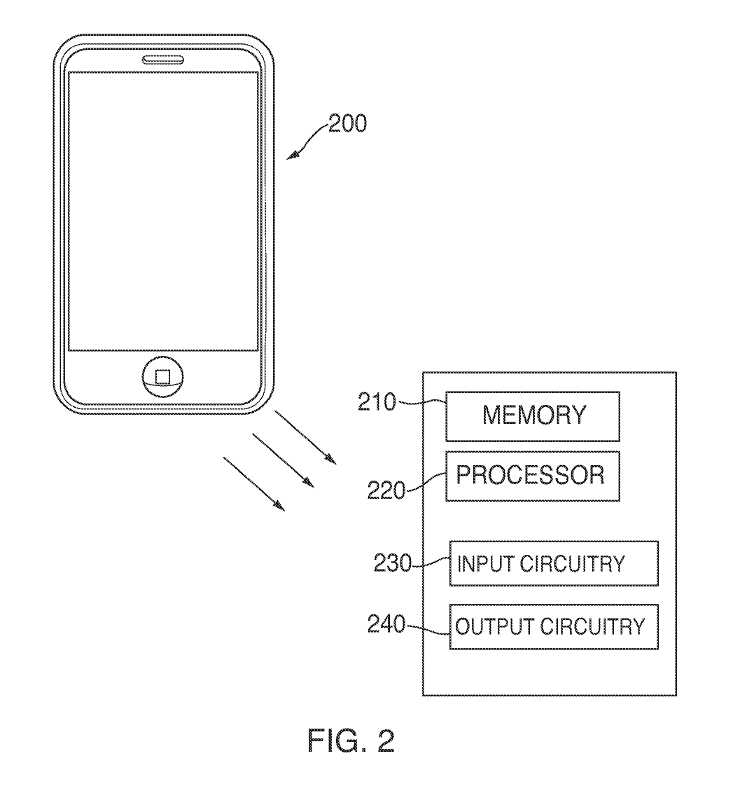

FIG. 2 is an illustrative diagram of an exemplary device in accordance with various embodiments. Device 200, in some embodiments, may correspond to any electronic device or system. Various types of devices include, but are not limited to, portable media players, cellular telephones or smart phones, pocket-sized personal computers, personal digital assistants (“PDAs”), desktop computers, laptop computers, tablet computers, and/or electronic accessory devices such as smart watches and bracelets. In some embodiments, however, device 200 may also correspond to a network of devices.

Device 200, in some embodiments, may include memory 210, one or more processors 220, input circuitry 230, and output circuitry 240. Persons of ordinary skill in the art will recognize that device 200 may include any number of components, and one or more additional components or modules may be added or omitted without deviating from the scope of the present disclosure. Additionally, one or more components may be combined or separated, and multiple instances of various components are also possible, however only one of each component is shown within device 200 for simplicity.

Memory 210 may include any suitable form of memory, such as cache memory, semi-permanent memory (e.g., RAM), or any other memory type, or any combination of. In some embodiments, memory 210 may be used in place of and/or in addition to an external memory or storage unit or device for storing data on device 200. Memory 210 may, in some embodiments, store a plurality of incentive rules. The incentive rules may, for example, include state and municipality laws, as well as regulations designed to attract businesses to various locations. The laws and regulations may create incentives that help a business expand within a certain location's jurisdiction. Each municipality and state, for instance, may have unique laws tailored to their needs. The vast number of laws created to entice businesses has resulted in hundreds of thousands of different ways a business may obtain incentives to expand in a certain jurisdiction.

Processor(s) 220 may include any suitable processing circuitry, such as one or more processors, capable of controlling the operations and functionality of device 200. In some embodiments, processor(s) 220 may facilitate communications between various components within device 200. For example, processor(s) 220 may cause output circuitry 240 to perform an associated output in response to one or more inputs being received by input circuitry 230. Processor(s) 220 may also run an operating system for device 200, applications resident on device 200, firmware applications, media application, and/or any other type of application, or any combination thereof functioning on, or in conjunction with, device 200.

Processor(s) 220 may process or analyze a wide array of disjointed, complex incentive rules and indicators. The number of incentive rules and different complexities associated with each of incentive rule makes it unfeasible for anyone to accurately assess their business expansion options manually. This technical problem faced by every expanding business is compounded by the fact that every business expansion decision is both time-sensitive and expensive. The ability to make a quick an accurate decision when choosing a location for business expansion while assessing all the available options is something the industry has not been able to do without extreme burden and undo manual analysis. Processor(s) 220 make it possible for a business to accurately and quickly assess its business expansion options.

Input circuitry 230 may include any suitable mechanism and/or component for receiving inputs from a user operating device 200. In some embodiments, input circuitry 230 may operate through the use of a touch screen and/or an interactive touch sensitive display screen. For example, input circuitry 230 may operate through the use of a multi-touch panel coupled to processor(s) 220, and may include one or more capacitive sensing panels. In some embodiments, input circuitry 230 may also correspond to a component or portion of output circuitry 240 which also may be connected to a touch sensitive display screen. For example, in response to detecting certain touch inputs, input circuitry 230 and processor(s) 220 may execute one or more functions for device 200 and/or may display certain content using output circuitry 240.

Output circuitry 240 may include any suitable mechanism or component for generating outputs to a user operating device 200. For example, output circuitry 240 may, in some embodiments, present one or more locations for which business expansion incentives are available to a user on device 200. Output circuitry 240 may operate a display screen that may be any size or shape, and may be located on one or more regions/sides of device 200. For example, output circuitry 240 may operate a display screen that may fully occupy a first side of device 200. Output circuitry 240 may also operate a display screen that may only occupy a portion of a first side of device 200. Various display screen types include, but are not limited to, liquid crystal displays (“LCD”), monochrome displays, color graphics adapter (“CGA”) displays, enhanced graphics adapter (“EGA”) displays, variable graphics array (“VGA”) displays, 3-D displays, high-definition (“HD”) displays, or any other display type, or any combination thereof.

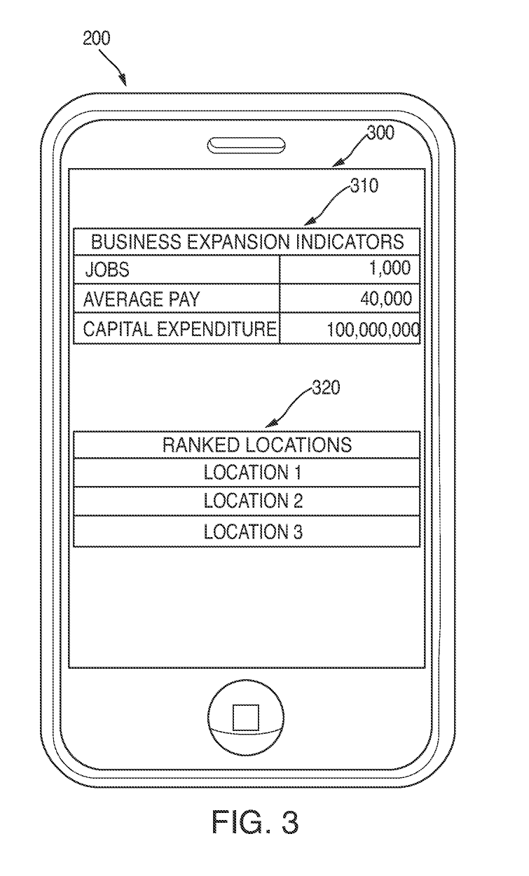

FIG. 3 is an illustrative diagram of a user interface displayed on a device showing various inputted indicators and displayed ranked locations in accordance with various embodiments. User interface 300 of FIG. 3 may, in some embodiments, be displayed on output circuitry 240 of device 200. In some embodiments, a user may input one or more receiving indicators 310 into device 200 using input circuitry 230. Receiving indicators 310 may then be displayed within user interface 300.

In one illustrative embodiment, indicators 310 may correspond to indicators the user may input for business expansion. The indicators for this embodiment may include, but are not limited to, an amount of jobs associated with the business expansion, an average wage of those jobs, and a capital expenditure associated with the business expansion. Persons of ordinary skill in the art will recognize that the aforementioned types of indicators are merely exemplary, and any additional parameter may be used.

In the exemplary embodiment, processor(s) 220 may transforms the business expansion indicators and the wide array of incentive rules into one or more locations where incentives for business expansion are determined to be available. Processor(s) 220 may also rank the newly determined available locations. The ranking may be made based on available business expansion incentives. The ranking may also be made based on a geographic preference of the user or business. After the rankings are determined, processor(s) 210 may instruct output circuitry 240 to display ranked locations 320 within user interface 300. Thus, the inputted parameters are transformed into a clear and accurate representation of possible business expansion locations for the user to view.

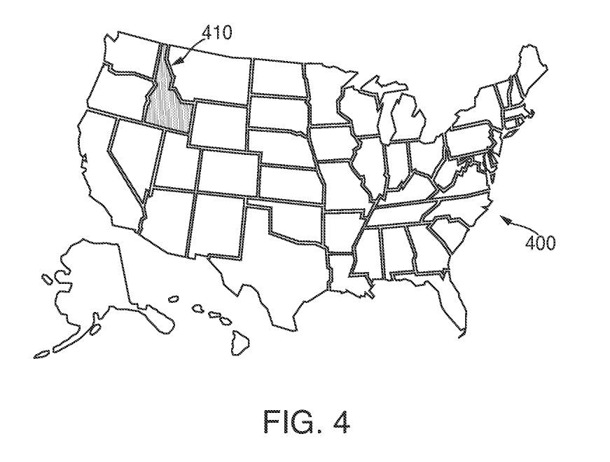

FIG. 4 is an illustrative diagram of another image of the continental United States of America showing a user selected state as a geographic preference in accordance with various embodiments. As one particular non-limiting example, a specific state (e.g., Idaho) may be analyzed. Map 400 of the United States of America may include a selection of a state 410. In one particular example, as described in greater detail below, state 410 may correspond to Idaho. A user may select the state in a variety of ways. For example, a user may contact output circuitry 240 displaying map 400 about where the desired state, such as state 410, is located. As another example, a user may type in a name of the state, which may select state 410. As another example, a user may select a state from a drop-down list. Persons of ordinary skill in the art will recognize that any suitable selection mechanism may be used to select state 410, and the aforementioned are merely exemplary.

In one embodiment, memory 210 may include incentive rules for a state, such as Idaho. The incentive rules may be found, in part, in chapter 47, title 67 of the Idaho State Code. Within title 67, sections 4737, 4738, 4739, 4740, 4741, 4742, 4743 and 4744, control Idaho's tax reimbursement incentive. Under these statutes, companies in rural areas must create at least 20 new jobs to qualify for an incentive. Companies in urban centers must create at least 50 jobs to qualify for an incentive. Additionally, businesses must offer full-time employment and pay equal to or greater than the average wage in the county that they are planning on moving to. Furthermore, Idaho officials evaluate the eligibility of incentives based on a variety of factors including, but not limited to, the impact of the industry sector, the impact on the local economy, and/or the impact on the state economy. If a business qualifies for the incentives under these specific statutes, the business can receive a maximum credit of 30% on income, payroll, and sales taxes for up to 15 years. The amount of tax credit that is received is a sliding scale depending on how high the wages are, the strength of local support and how strong the impact on the economy is expected to be.

Because each state's laws require very specific knowledge regarding that state's local statistics, the incentive rules in the exemplary embodiment may include: an average wage in each county of Idaho, statistics relating to a current condition of each industry sector in Idaho, statistics relating to a current condition of each local economy, and statistics related to a current condition of the state's economy. Also, because of the subjective nature regarding the strength of local support, in order to determine how municipalities implement their laws, the incentive rules may include a list of the announced incentives packages over the past few years. Further complicating the analysis regarding each of these factors is that they are constantly changing and extremely specific for each region within each state. The combination of all of these rules allows for an accurate analysis in Idaho. For simplicity, announced incentive packages are not used in this particular example.

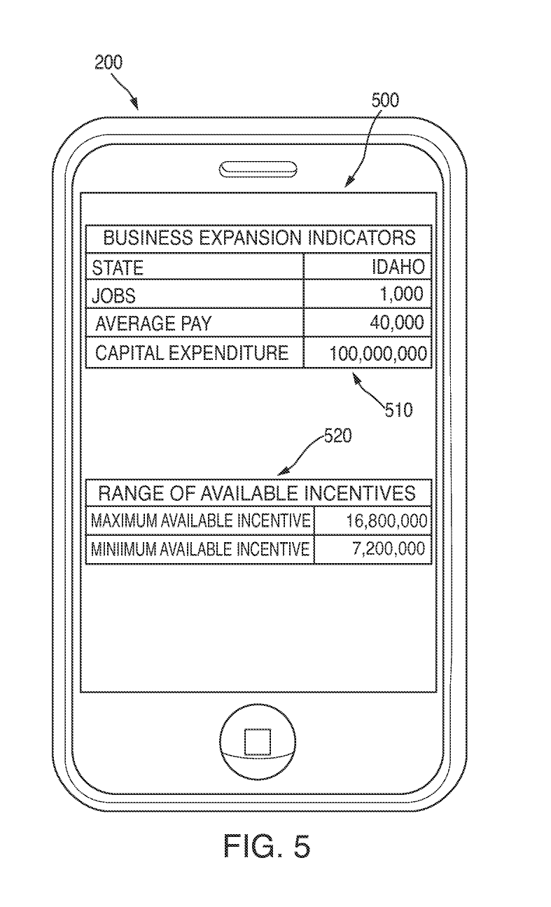

FIG. 5 is an illustrative diagram of a user interface displayed on a device showing various inputted indicators and displayed range of incentives in accordance with various embodiments. User interface 500 may include, in the illustrative embodiment, indicators 510. For example, indicators 510 may correspond to a state, a number or type of jobs associated with the business expansion to occur in the desired state, an average pay of those jobs, and/or capital expenditure needed for expanding business to that state. For exemplary purposes, a user may select the state of Idaho by selecting state 410 on map 400 of FIG. 4. In one embodiment, Idaho may be selected through the use of a drop-down list. As seen in user interface 500, Idaho may be displayed as the selected state for the business expansion in addition to an amount of jobs that may be created, an average pay for those jobs, and/or a capital expenditure needed for the business expansion to Idaho. As one illustrative example, the number of jobs may be 1,000, the average pay for those jobs may be $40,000 annually, and the capital expenditure may be $100,000,000.

In response to a user inputting indicators 510, processor(s) 220 may transform indicators 510 and the incentive rules for the selected state (e.g., Idaho), which may be stored in memory 210, into various available incentives for the state of Idaho. Processor(s) 220 may further determine one or more ranges of the determined available incentives. The ranges may include, for example, a maximum amount of available incentive and a minimum amount of available incentive.

Processor(s) 220 may then cause output circuitry 240 to display ranges of available incentives 520 within user interface 500. In this particular example, using the inputted indicators 510 and incentive rules stored in memory 210, the maximum amount of available incentive may be $16,800,000 and the minimum amount of available incentive may be $7,200,000. However, persons of ordinary skill in the art will recognize that different available incentives may also be displayed within user interface 500, and the aforementioned are merely exemplary.

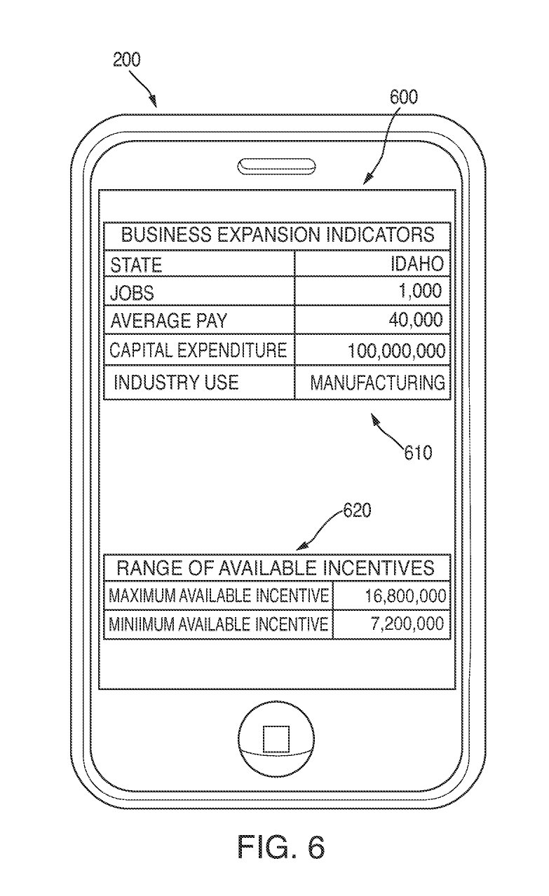

FIG. 6 is an illustrative diagram of another user interface displayed on a device showing various inputted indicators and a displayed range of incentives in accordance with various embodiments. User interface 600 may, in some embodiments, include business expansion indicators 610 and available incentive ranges 620. In some embodiments, business expansion indicators 610 may be substantially similar to business expansion indicators 510 of FIG. 5, with the exception that business expansion indicators 610 may further include an industry use. In an embodiment, business expansion indicators 610 may be either inserted in to the user interface or may be selected through the use of a drop-down menu. An industry use, as used herein, may refer to the type of industry that the business may be bringing to a location. Various types of industry use may include, but are not limited to, manufacturing, distribution, professional office, general office, and/or retail. Person of ordinary skill in the art will recognize that industry use may refer to any other industry or type of business. Furthermore, person of ordinary skill in the art will recognize that the aforementioned industry use categories are merely exemplary.

In one embodiment, the incentive rules may further include industry preclusions. An industry preclusion, as used herein, may refer to a state or municipality law or regulation that prevents certain industry uses from receiving business expansion incentives. While there are values inputted for the listed indicators 610, persons of ordinary skill in the art will recognize that the values are merely exemplary.

In some embodiment, as described above, processor(s) 220 may transform business expansion indicators 610 including industry use and the wide array of incentive rules into a range of incentives available for a certain geographic preference. These ranges may include a maximum amount of available incentives and a minimum amount of available incentives. For example, for the state of Idaho, the number of jobs created may be 1,000 jobs, the average pay may be $40,000 annually, the capital expenditure may be $100,000,000, and the industry use may be “manufacturing”. In response to inputting these values into device 200, for example, ranges 620 may be determined and displayed on user interface 600. For example, based on the aforementioned values, a maximum amount of available incentives may be $16,800,000, while a minimum amount of available incentives may be $7,200,000. While the values for ranges 620 may be substantially similar to ranges 520 of FIG. 5, persons of ordinary skill in the art will recognize that these values may change based different industry use indicators and/or industry preclusion rules.

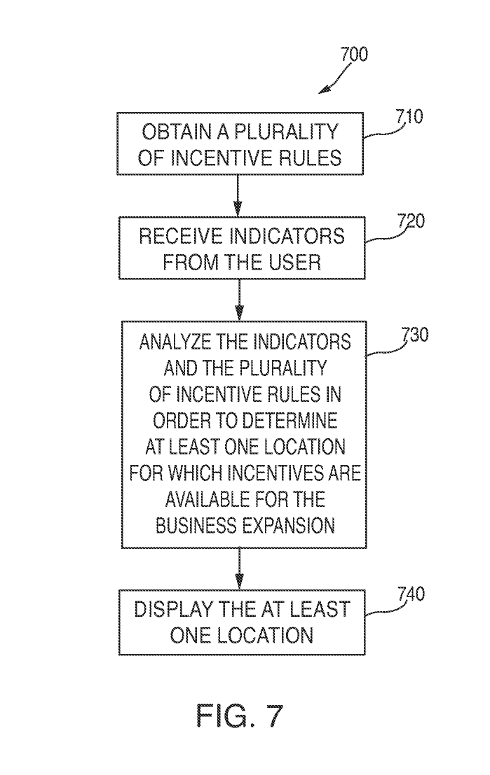

FIG. 7 is an illustrative flowchart of a process for providing a user with one or more business expansion locations in accordance with various embodiments. Process 700, in one exemplary embodiment, transforms incentive rules and indicators, stored in memory on a device and/or provided by a user, into at least one location where incentives for a business expansion may be available. Process 700 of FIG. 7 may, in some embodiments, begin at step 710. At step 710, a plurality of incentive rules are obtained. For example, various incentive rules for various states or regions within each state may be stored in memory on a device, such as device 200 of FIG. 2. In response to entering into a mode to determine available incentives, device 200 may retrieve the various incentives rules from memory so that they may be used for analysis.

The incentive rules may include, amongst other rules and information, state and municipality laws and regulations designed to attract businesses to enter the state or municipality, and/or to expand there. These laws and regulations may generate incentives to help attract a business to expand in that state's jurisdiction. Each municipality and state may have unique laws tailored to that state's particular needs. The number of laws created results in hundreds of thousands of different ways for a business to get incentives to expand in that state or region. The sheer amount of rules and the intricacies therein make it an unfeasible task for a user or a business to make an accurate analysis of available expansion incentives. The amount of work associated with discovering the available incentives in one municipality is quite significant. The fact that business expansion decisions are time-sensitive and expensive only compounds the technical problem. Process 700 provides users a method for addressing this technical problem in a way that the industry has not been able to do. In the exemplary, non-limiting embodiment, all of these rules are obtained at step 710. In some embodiments, the obtained rules may include one or more industry preclusions.

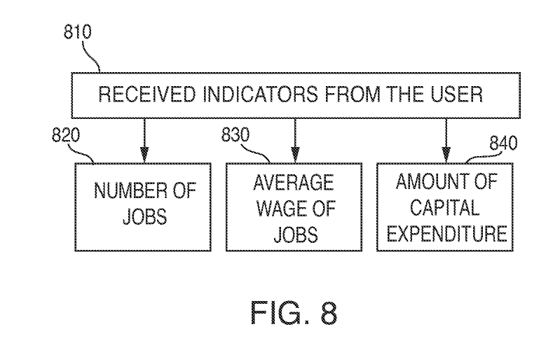

At step 720, the one or more indicators provided by the user may be received. In an embodiment, these indicators may include a number of jobs related to the business expansion, an average wage of the jobs, and an amount of capital expenditure. The received indicators may, in some embodiments, also include an industry use. A more detailed description of various types of industry uses may be seen below in the description of FIG. 8.

At step 730, the industry rules and indicators may be processed or analyzed to determine one or more locations where incentives may be available for business expansion. The analysis may transform the indicators and incentive rules into usable values describing a state or region's potential amount of incentives. Thus, users and businesses may be able to obtain timely and accurate information that was previously not available to them.

At step 740, the one or more locations where business expansion incentives are available are displayed to the user in a clear and informative manner. In some embodiments, the results of the analysis may be displayed through the use of a display screen operated by output circuitry 240. For example, a minimum and maximum amount of available incentives may be displayed within a user interface, such as user interface 500 of FIG. 5.

FIG. 8 is an illustrative block diagram including various indicators in accordance with various embodiments. In some embodiment, one or more received indicators from the user 810 may include a number of jobs 820, an average wage of jobs 830, and an amount of capital expenditure 840.

Jobs, as referred to in number of jobs 820 may refer to any person receiving monetary compensation at the location of the business. The number of jobs 820 may also refer to volunteers, or those who work for no monetary amount. Jobs may also refer to interns or apprentices or those who are associated with a business for learning purposes. This may include students from schools in surrounding areas that may learn at a business. Furthermore, jobs may also correspond to a total number (e.g., part-time, full time, volunteers, etc.) of people that are working at a business's new location, or only a portion of the business's work force. Persons of ordinary skill in the art will recognize that any activity may be referred to as a job, and the aforementioned are merely exemplary.

The average, as used in the indicator average wage of jobs 830, is not meant to be limited to the mean of the wage. The average may also correspond to the median wage, the mode of the wage, or the range of the wage. However, a person of ordinary skill in the art will recognize that the average can correspond to any method of describing a collective number of wages that an incentive rule might require.

The wage, as used in the indicator average wage of jobs 830, may correspond to an annual salary of a typical employee of a business. The wage may also correspond to an hourly-based wage. The wage may also correspond, in some embodiments, to performance-related pay based wages such as commission-based pay. While only a few methods of payment have been discussed, person having ordinary skill in the art will recognize that the term wage can correspond to any form or type of compensation for labor, and the aforementioned are merely exemplary.

Capital expenditure, as used in the indicator amount of capital expenditure 840, may correspond to long term assets such as equipment or infrastructure. This may correspond to acquiring physical assets such as a building, property, or equipment. In some embodiments, capital expenditure 840 may also correspond to any construction or repairs needed to be performed on a potential physical asset, such as repairing a roof on a building. As yet another example, capital expenditures may include equipment expenses such as buying new machines. In yet another example, capital expenditure may correspond to construction of new facilities or expansion of pre-existing facilities (e.g., building an entirely new factory). The aforementioned examples are not meant to limit the definition of capital expenditure. Person of ordinary skill in the art will recognize that the definition of capital expenditure can correspond to any asset because a capital expenditure can be defined by incentive rules provided by localities.

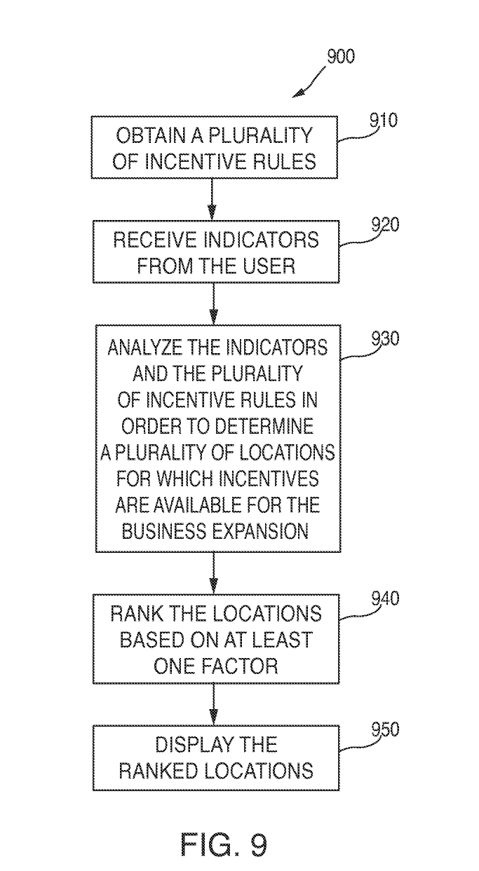

FIG. 9 is an illustrative flowchart of a process for providing a user with ranked business expansion locations in accordance with various embodiments. Process 900, in one exemplary embodiment, transforms incentive rules and indicators, stored in memory on a device and/or provided by a user, into a list of more than one location where incentives for a business expansion may be available.

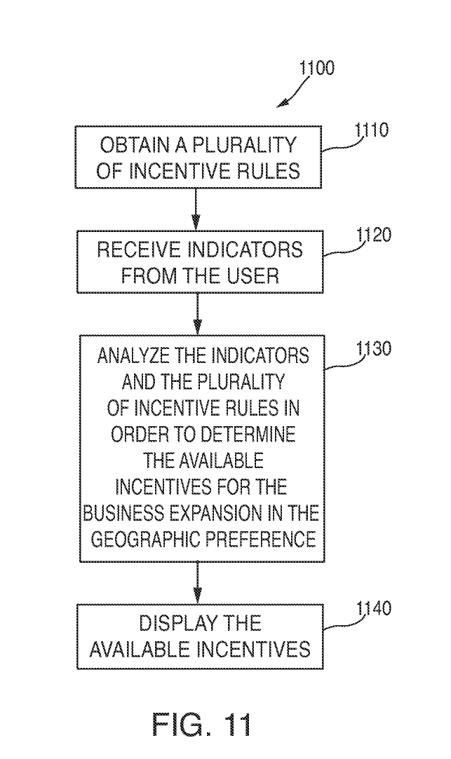

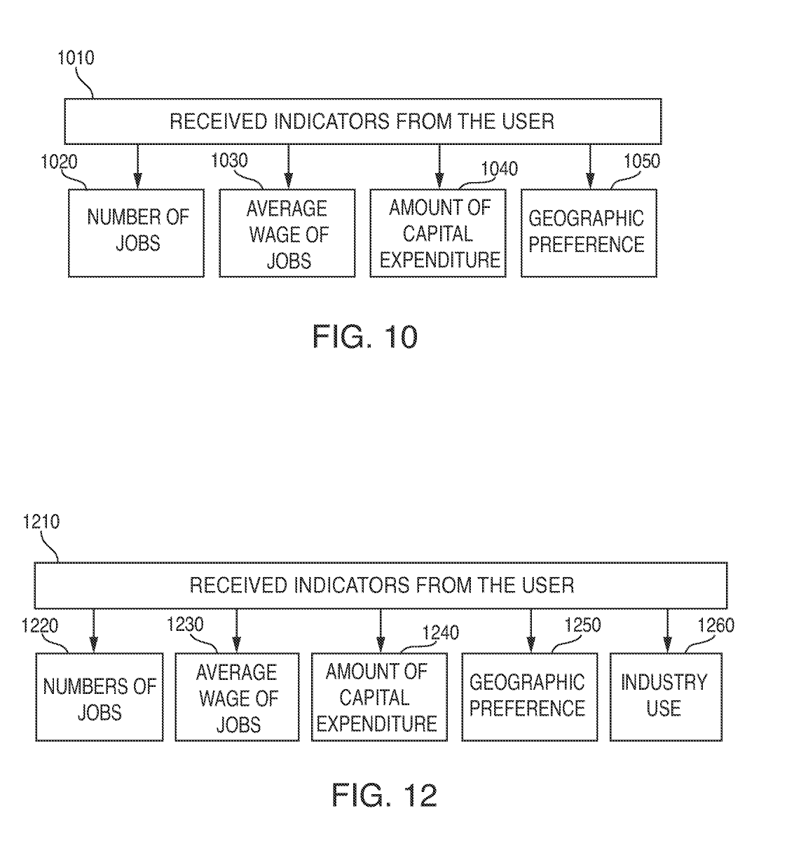

Process 900 of FIG. 9 may, in some embodiments, begin at step 910. At step 910 a plurality of incentive rules are obtained. At step 920, one or more indicators provided by the user are received. In an embodiment, these indicators may include a number of jobs related to the business expansion, an average wage of the jobs, an amount of capital expenditure, and/or a geographic preference. The indicators may further include an industry use. A more detailed description may be seen below with reference to FIG. 10. At step 930 the incentive rules and indicators, including the industry use, are analyzed. This analysis transforms disjointed, complex industry rules and indicators into more than one location for which incentives are available for a business expansion. Step 930 analyzes the incentive rules and indicators in a timely, complete, and accurate way that the industry has not been able to accomplish. Steps 910, 920, and 930 may be substantially similar to steps 710, 720 and 730 with the exceptions that step 920 may include a geographic preference and step 930 may determine more than one location where business expansion incentives are available.

At step 940, the locations that are found with available incentives may be ranked based on at least one factor. In one embodiment, the at least one factor may be a geographic preference for the business. In another embodiment, the at least one factor may be an amount of available incentives. While only two factors are described, persons of ordinary skill in the art will recognize that the ranking of multiple locations may occur in any suitable manner, and the aforementioned are merely exemplary.

At step 950, the ranked locations for which business incentives are available may be displayed in a ranked, clear, and informative manner. The results of the analysis may be displayed through the use of a display screen operated by output circuitry 240. For example, three different locations where incentives may be available for a particular business may be displayed on the user device. The three locations may, in some embodiments, be displayed in an order such that a location offering the most amount of incentives for a business may be ranked first, the location offering the second most amount of incentives may be ranked second, and the location offering the least amount of incentives may be ranked third.

FIG. 10 is an illustrative block diagram including various indicators in accordance with various embodiments. In an embodiment, one or more obtained indicators from the user 1010 may include a number of jobs 1020, an average wage of jobs 1030, an amount of capital expenditure 1040, and a geographic preference 1050. In some embodiments, number of jobs 1020, average wage of jobs 1030, and amount of capital expenditure 1040 may be substantially similar to number of jobs 820, average wage of jobs 830, and amount of capital expenditure 840 of FIG. 8, respectively, and the previous description may apply.

A geographic preference 1050, as described above, may correspond to the entire United States of America, an area in the United States of America (e.g., a state), a grouping of states (e.g., the southwest), a specific state, and/or an area within a state (e.g., a city or county). Furthermore, a geographic preference 1050 may, in some embodiments, include additional countries worldwide, as well as various regions or cities within one or more additional countries.

FIG. 11 is an illustrative flowchart of a process for providing a user with available incentives for a geographic preference in accordance with various embodiments. Process 1100 transforms incentive rules and indicators into a value of business expansion incentives available in a geographic preference in a way previously not available to the industry.

Process 1100 of FIG. 11 may, in some embodiments, begin at step 1110. At step 1110 a plurality of incentive rules may be obtained. At step 1120, one or more indicators provided by the user may be received. In an embodiment, these indicators may include a number of jobs related to the business expansion, an average wage of the jobs, an amount of capital expenditure, a geographic preference and an industry use. A more detailed description of the received indicators may be seen below with reference to the description of FIG. 12. Steps 1110 and 1120 may, in some embodiments, be substantially similar to steps 710 and 720 of FIG. 7, with the exception that step 1120 may also include a geographic preference and an industry use.

At step 1130, the obtained indicators and the plurality of incentive rules are processed to determine an available amount of incentives for business expansion in the geographic preference. The analysis uses a wide array of disjointed, complex rules and indicators to provide users with a timely, accurate analysis. This timely, accurate analysis transforms the incentive rules and indicators into a value of available incentives for a business expansion in a geographic preference. The analysis provides users and businesses with information that was previously not available to them.

At step 1140, the available incentives for a business expansion in a geographic preference are displayed in a clear and informative manner. In some embodiment, the available incentives may be displayed in a range format. This range format may have a maximum value of incentives available and a minimum value of incentives available. The results of the analysis may be displayed on a display screen operated by output circuitry 240 of device 200. For example, the displayed incentives may include a maximum monetary amount of incentives available to a business looking to expand in a certain geographic preference as well as the minimum monetary amount of incentives that may be available. By displaying the maximum and minimum amounts of available incentives, a business may be able to decide whether or not the risk of expansion in that location is lucrative enough to warrant the expansion.

FIG. 12 is an illustrative block diagram including various indicators in accordance with various embodiments. In some embodiment, the obtained indicators 1210 may include a number of jobs 1220 related to the business expansion, an average wage of the jobs 1230, an amount of capital expenditure 1240, a geographic preference 1250 and an industry use 1260. In some embodiments, number of jobs 1220, average wage of jobs 1230, and amount of capital expenditure 1240 may be substantially similar to number of jobs 820, average wage of jobs 830, and amount of capital expenditure 840 of FIG. 8, respectively, and the previous description may apply. Furthermore, geographic preference 1260 may be substantially similar to geographic preference 1050 of FIG. 10, and the previous description may apply.

An industry use 1260, as described above, may refer to the type of industry that the business may be bringing to a location. Various types of industry use may include, but are not limited to, manufacturing, distribution, professional office, general office, and/or retail. Person of ordinary skill in the art will recognize that any other type of industry use may be used, and the aforementioned are merely exemplary.

It should be appreciated that the various embodiments described above can be implemented by software, but can also be implemented in hardware or a combination of hardware and software. The various systems described above can also be embodied as computer readable code on a computer readable medium. The computer readable medium can be any data storage device that can store data, and that can thereafter be read by a computer system. Examples of computer readable mediums include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The above described embodiments of the invention are presented for purposes of illustration and not of limitation.

What is claimed is:

1. A device for providing a user with business expansion options, the device comprising:
memory comprising:
a plurality of incentive rules;
input circuitry operative to receive indicators, the indicators comprising:
a number of jobs related to the business expansion;
an average wage of the jobs; and
an amount of capital expenditures related to the business expansion;
a processor operative to process the indicators and the plurality of incentive rules in order to determine at least one location for which incentives are available for the business expansion; and
output circuitry operative to display the at least one location to the user.

2. The device of claim 1, wherein:
the at least one location comprises a plurality of locations.

3. The device of claim 2, wherein:
the processor is further operative to rank the locations based on at least one factor; and
the output circuitry is further operative to display the ranked locations.

4. The device of claim 3, wherein the at least one factor comprises:
the amount of available incentives for the business expansion.

5. The device of claim 3, wherein the at least one factor comprises:
a geographic preference.

6. The device of claim 1, wherein the indicators further comprise:
a geographic preference.

7. The device of claim 6, wherein:
the processor is further operative to process the indicators and the plurality of incentive rules in order to determine the value of available incentives for the business expansion in the geographic preference; and
the output circuitry is further operative to display the available incentives to the user.

8. The device of claim 6, wherein:
the processor is further operative to process the indicators and the plurality of incentive rules in order to determine a range of available incentives for the business expansion in the geographic preference, the range comprising a maximum value of available incentives and a minimum value of available incentives; and
the output circuitry is further operative to display the range to the user.

9. The device of claim 8, wherein:
the geographic preference is a State.

10. The device of claim 9, wherein the indicators further comprise:
an industry use.

11. The device of claim 10, wherein the incentive rules comprise:
an industry preclusion.

12. The device of claim 1, wherein the indicators further comprise:
an industry use.

13. The device of claim 12, wherein the incentive rules comprise:
an industry preclusion.

14. A method for providing a user with business expansion options, the method comprising:
obtaining a plurality of incentive rules;
receiving indicators provided by the user, the indicators comprising:
a number of jobs related to a business expansion;
an average wage of the jobs; and
an amount of capital expenditures associated with the business expansion;
processing the indicators and the plurality of incentive rules in order to determine at least one location where incentives are available for business expansion; and
displaying the at least one location to the user.

15. The method of claim 14, wherein the at least one location comprises a plurality of locations, the method further comprises:
ranking the plurality of locations based on at least one factor.

16. The method of claim 15, wherein displaying further comprises:
displaying the ranked plurality of locations to the user.

17. The method of claim 15, wherein the at least one factor comprises:
an amount of available incentives for business expansion.

18. The method of claim 15, wherein the at least one factor comprises:
a geographic preference.

19. The method of claim 14, wherein the indicators further comprise:
a geographic preference.

20. The method of claim 19, further comprising:
processing the indicators and the plurality of incentive rules in order to determine an amount of available incentives for the business expansion in the geographic preference; and
displaying the amount of available incentives to the user.

21. The method of claim 19, further comprising:
processing the indicators and the plurality of incentive rules in order to determine a range of available incentives for the business expansion in the geographic preference, the range comprising a maximum amount of available incentives and a minimum amount of available incentives; and
to displaying the range to the user.

22. The method of claim 21, wherein the geographic preference is a State.

23. The method of claim 14, wherein the indicators further comprise:
an industry use.
